(19) United States
(12) Patent Application Publication
(10) Pub. No.: US 2003/0210044 A1
(43) Pub. Date: Nov. 13, 2003

(54) Missing pulse steady state free precession

(76) Inventors: Ken-Pin Hwang, Cleveland, OH (US); Chris Flask, Avon Lake, OH (US); Jonathan S. Lewin, Beachwood, OH (US); Jeffrey L. Duerk, Avon Lake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/327,840

(22) Filed: Dec. 23, 2002

Related U.S. Application Data
(60) Provisional application No. 60/380,186, filed on May 13, 2002.

(51) Int. Cl. G01V 3/00

(52) U.S. Cl. 324/307; 324/309

(57) ABSTRACT

MP-SSFP sequences, including intervolume sequences and CHESS sequences, that facilitate improving MR imaging are provided. Slice selective pulses in an MP-SSFP sequence are altered so that a smaller set of spins refocus at echo time during a missed pulse, reducing artifacts in an image reconstructed from a signal acquired from the refocused spins. In one example, a slice selective pulse is replaced with a chemical shift selective pulse so that the intersecting sets of spins are chemically related. In another example, an RF pulse is altered so that it acts as an intervolume selecting pulse.

### CROSS REFERENCE TO RELATED APPLICATIONS

This application claims priority to U.S. Provisional Application No. 60/380,186 titled “Intervolume Imaging With Missing Pulse Steady State Free Precession (MP-SSFP) and Chemical Shift Missing Pulse Steady State Free Precession”, filed May 13, 2002, which is incorporated herein by reference.

### TECHNICAL FIELD

This application relates generally to the nuclear magnetic resonance spectroscopy and magnetic resonance imaging arts and more particularly to a magnetic resonance imaging (MRI) system that performs intervolume imaging and chemical shift selective imaging with MP-SSFP.

### BACKGROUND

In steady state free precession sequences, a sample (e.g., human tissue) is subjected to sequences of radio frequency (RF) pulses that set up the protons in a steady state free precession. While protons are precessing in a steady state, sequence RF pulses can be selectively skipped and a signal can be acquired from the protons precessing in the steady state during the skipped pulse(s). MP-SSFP is a steady state technique, that is, a technique wherein the RF spacing is less than the relaxation rates of the imaged tissues. Conventionally, an MP-SSFP sequence includes two or more identical RF pulses that are intended to excite a fixed set of spins. During the missing RF pulse period, the excited set of spins are refocused, and thus emit a signal that can be acquired. An example MP-SSFP sequence is described in Patz S. et al, Magn Reson Med; 10(2): 194-209.

### SUMMARY

The following presents a simplified summary of methods, systems, and computer readable media for improving MRI images through the use of in-plane volume and/or chemical shift selectivity as performed with techniques like chemical shift selective (a.k.a. CHESS) pulses. This summary is not an extensive overview and is not intended to identify key or critical elements of the methods, systems, computer readable media, and so on or to delineate the scope of these items. This summary provides a conceptual introduction in a simplified form as a prelude to the more detailed description that is presented later.

Improvements can be achieved by altering an MP-SSFP sequence pulse so that different pulses excite different but intersecting sets of protons. The improvement to MRI processing is related to selective excitation of spins achieved by altering RF pulses in an SSFP sequence so that the RF pulses excite different, but intersecting, sets of spins. By way of illustration, geographically, if a first pulse excites a geographic segment (e.g., slice) of a sample, and a second pulse excites a different, but intersecting, geographic segment (e.g., “intervolume”) of the slice, then the signal acquired during a missing third pulse can image the intervolume of the slice rather than the entire slice. This provides improvements over conventional systems where both first and second pulses excite the same set of protons and the signal acquired during the missing pulse(s) images the entire volume.

By way of further illustration, chemically, a first pulse (or pulses) may excite a first set of protons that lie within a selected slice and a second pulse (or pulses) may excite a second set of protons that share a chemical composition. If the first and second sets of protons intersect, then the signal acquired during a missing third pulse (or pulses) can image the protons of the chemical composition selected by the second RF pulse(s) that lie within the slice selected by the first RF pulse(s). Additionally, and/or alternatively, signal may be acquired to image the protons excited by only one of the pulses. While MP-SSFP sequences with two excitation pulses and one missing third pulse are described herein, it is to be appreciated that various MP-SSFP intervolume and/or CHESS pulse sequences may have varying excitation and acquisition phases in their sequences, and that this application is intended to cover such sequences, when a combination of excitation pulses are employed to excite intersecting sets of spins in a steady state sequence.

In one example, this application describes an MP-SSFP MRI method that includes exciting a first set of spins during a first RF pulse, exciting a second set of spins during a second RF pulse, where the second set of spins intersects with the first set of spins, skipping a pulse, and acquiring an MR signal from the intersection of the first and second set of spins. In another example, the method further includes producing an image from the MR signal. In yet another example, the method includes acquiring an MR signal from the spins that were excited by either the first RF pulse or the second RF pulse, but not by both, and producing an image, or enhancing an image with that MR signal.

In another example, the application describes an example MRI system that includes an RF pulse generator that generates an MP-SSFP sequence that includes a slice selective RF pulse (or pulses) and an intervolume and/or CHESS RF pulse (or pulses). The example MRI system also includes an MR signal detector that acquires an MR signal (or signals) from a set of spins refocused during a missing pulse (or pulses) in the MP-SSFP sequence. The set of spins may be, for example, the intersection of spins excited during the slice selective RF pulse(s) and the CHESS RF pulse(s). In another example, the system also includes an image generator that produces an image from the MR signal. In yet another example, the MR signal detector acquires a signal from the spins that were excited by either the first RF pulse (or pulses) or the second RF pulse (or pulses).

Certain illustrative example methods, systems, and computer readable media are described herein in connection with the following description and the annexed drawings. These examples are indicative, however, of but a few of the various ways in which the principles of the systems, methods, and computer readable media may be employed and thus are intended to be inclusive of equivalents. Other advantages and novel features may become apparent from the following detailed description when considered in conjunction with the drawings.

### BRIEF DESCRIPTION OF THE DRAWINGS

FIG. 1 illustrates an example MRI system.

FIG. 2 illustrates an example MP-SSFP sequence.

FIG. 3 illustrates an example MP-SSFP CHESS sequence.

FIG. 4 illustrates a general framework of an example selective MP-SSFP sequence with two RF pulses per cycle.

FIG. 5 illustrates an example MP-SSFP CHESS sequence.

FIG. 6 shows a sample MRI image acquired with an MP-SSFP CHESS sequence.

FIG. 7 is a flow chart illustrating one example method for employing an MP-SSFP intervolume and/or CHESS sequence.

FIG. 8 is a flow chart illustrating another example method for employing an MP-SSFP intervolume and/or CHESS sequence.

FIG. 9 illustrates an example system for producing an image from a signal acquired in response to an MP-SSFP sequence.

FIG. 10 illustrates an example MP-SSFP CHESS sequence with a rebalancing gradient that facilitates acquiring a gradient MR echo.

### DETAILED DESCRIPTION

Example methods, systems, and computer media are now described with reference to the drawings where like reference numerals are used to refer to like elements throughout. In the following description, for purposes of explanation, numerous specific details are set forth to explain the methods, systems, and computer readable media. It may be evident, however, that the methods, systems, and computer readable media can be practiced without these specific details. In other instances, well-known structures and devices are shown in block diagram form in order to simplify description.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Software”, as used herein, includes but is not limited to, one or more computer readable and/or executable instructions that cause a computer or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel, and other manners.

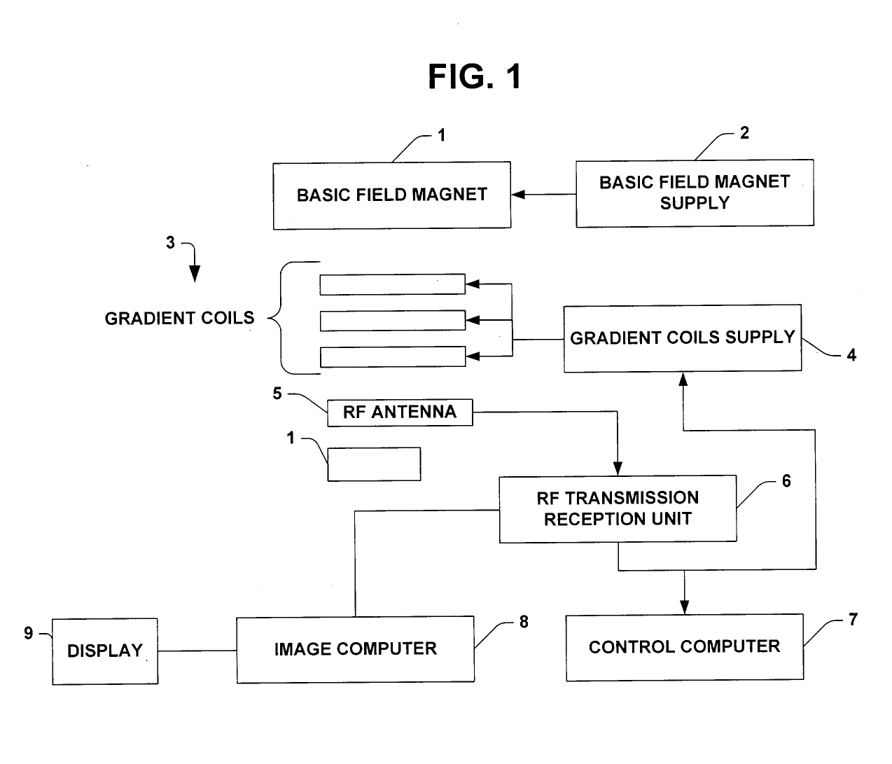

FIG. 1 shows one example of a magnetic resonance apparatus. The apparatus includes a basic field magnet 1 and a basic field magnet supply 2. The system has gradient coils 3 for respectively emitting the gradient magnetic fields G_{S}, G_{P} and G_{R}, operated by a gradient coils supply 4. An RF antenna 5 is provided for generating RF pulses, and for receiving resulting magnetic resonance signals from an object to which the RF pulses are directed. Alternatively, separate RF transmission and reception coils can be employed. The RF antenna 5 is operated by an RF transmission/reception unit 6. The gradient coils supply 4 and the RF transmission/reception unit 6 are operated by a control computer 7.

The control computer 7 can be programmed to produce an MP-SSFP sequence with pulses that excite intersecting sets of spins. The structure of the MP-SSFP sequence allows, for example, spins of the intersection of two spin sets to refocus at the echo time. Other spins are excluded by both RF pulses or dephased at the echo time. CHESS pulses programmed into the control computer 7 and emitted in association with the RF transmission reception unit 6 result in a near bandlimited frequency response to a sequence, as opposed to periodic profiles seen in other chemical shift selective steady state sequences. The duration of a CHESS pulse can be computed to balance total acquisition time and chemical shift resolution. Longer CHESS pulses result in finer resolution of chemical shift. Thus, the control computer 7 can be programmed to manipulate the location, duration, frequency and so on of pulses, including the CHESS pulse(s) in an MP-SSFP sequence in the MRI system.

The magnetic resonance signals received from the RF antenna 5 can be employed to generate an image, and thus are subject to a transformation process, such as a two dimensional fast Fourier transform (FFT), which generates pixelated image data. The transformation can be performed by an image computer 8 or other similar processing device. It is to be appreciated that reconstruction algorithms other than two dimensional Fourier transformation can also be employed with some pulse sequences. The image data may then be shown on a display 9.

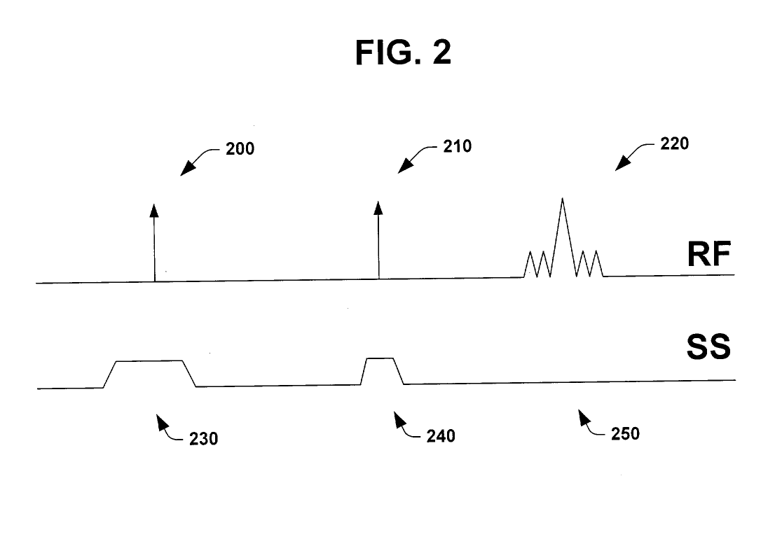

FIG. 2 illustrates an example MP-SSFP sequence. The MP-SSFP sequence includes a first RF pulse 200 that has a first set of characteristics (e.g., frequency range, frequency center, duration, pulse shape) and a first gradient pulse 230 with amplitude, slew rate, and duration characteristics that will excite a first set of spins. The sequence also includes a second RF pulse 210 that has a second set of characteristics (e.g., frequency range, frequency center, duration, pulse shape) and a second gradient pulse 240 that will, therefore, excite a second set of spins. Conventionally, the second pulse has the same characteristics as the first pulse and thus excites the same set of spins. In non-imaging applications (e.g., spectroscopy), the MP-SSFP sequence would include RF pulses but would not include gradient pulses.

At 250, a pulse is skipped. The intersection of the spins excited by the first pulse 200 and the second pulse 210 will refocus and emit signal 220 during the missed third pulse 250. Thus, a smaller set of data is acquired from a more relevant set of spins, leading to improvements in MRI images (e.g., artifact reduction, reduced acquisition time).

In an MP-SSFP sequence, if a first pulse (or pulses) excites a first set of protons (e.g., lipids and water), and a second pulse (or pulses) excites a different but intersecting set of protons (e.g., lipids or water), then a signal acquired during a missing third pulse (or pulses) can be an image of the intersection of the two excited sets rather than the complete set of protons. This provides improvements over conventional systems where both a first and a second pulse excite the same set of protons and the signal acquired during a missing pulse images a less selective set of protons.

In one example, the intersecting sets are geographically related. A first and second pulse select an intervolume of a sample that is the intersection of two geographically intersecting slices of protons. Since the signal is received from a smaller set of protons, there are less undesired signal components from outside the field of view (FOV), which leads to improvements in processing speed. Furthermore, with data being received from this smaller set of protons, the need to process out artifacts is mitigated. Conventional systems and methods may address artifact reduction by, for example, adding more phase encoding lines, which increases the amount of data to acquire and process and thus increases overall imaging time. By limiting FOV to protons emitting from an intersection of sets, the total amount of data to collect is reduced and thus processing time is reduced. Furthermore, the incidence of artifacts is also reduced, since protons that are not in the intersection of the spin sets will not refocus at the image acquisition time, yielding fewer artifacts and/or less severe artifacts.

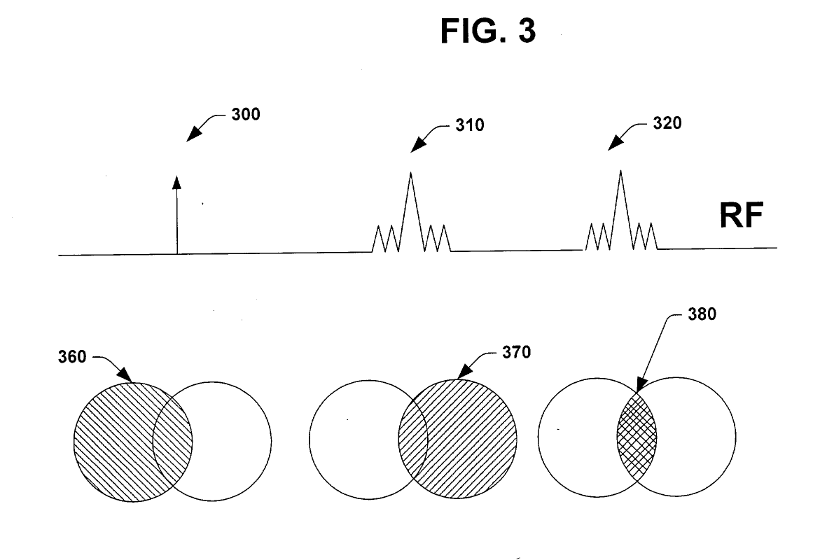

FIG. 3 illustrates an example MP-SSFP CHESS sequence. This type of sequence is employed, for example, when the intersecting sets are geographically and chemically related. An MP-SSFP CHESS sequence can include, for example, a first pulse (or pulses) that excites both water and fat in a slice of a sample and a second pulse (or pulses) that excites either the water or the fat. During a missing third pulse (or pulses), the intersection of the sets will emit an MR signal, which facilitates distinguishing water from fat (or fat from water) in a sample. While fat and water are described, it is to be appreciated that similar methods may be employed for other spectrally shifted components of the image or spectroscopic experiment.

Thus, FIG. 3 illustrates an MP-SSFP CHESS sequence with a first RF pulse 300 that has a first set of characteristics (e.g., bandwidth, duration, center frequency) that excites a first set 360 of spins. For example, the first RF pulse 300 may have a duration of 1-5 ms, and may be applied in the presence of a magnetic field gradient so that both fat and water protons in a slice are excited. The MP-SSFP sequence also includes a second RF pulse 310 that excites a second, intersecting set 370 of spins. For example, the second RF pulse 310 may have a bandwidth of 100-200 Hz, a duration of 5-10 ms, and may be applied in the absence of gradients, with the center of its frequency range positioned so that either water or fat protons, but not both, are excited. Adjusting the bandwidth, shifting the center frequency, and transmitting an RF pulse in the absence of magnetic field gradients can make the pulse “chemical shift selective” and thus the altered RF pulse in the MP-SSFP pulse sequence can be referred to as a CHESS pulse.

The CHESS MP-SSFP sequence also includes a missing pulse. During the time when the “missing RF pulse” would have been generated, the intersection 380 of spins excited by both the first RF pulse 300 and the second RF pulse 310 will refocus and emit an MR signal 320 that can be acquired. During the missing third pulse, the signal 320 that is acquired is from either fat or water, but not both, as is conventional.

While FIGS. 2 and 3 illustrate MP-SSFP sequences with three time points, in which two pulses and one “dropped pulse” occur, it is to be appreciated that other MP-SSFP sequences in which a variety of types and numbers of RF pulses that excite intersecting sets of spins can be employed in accordance with aspects of the present invention. Thus, for example, a sequence may have four time points including two pulses of one type alternating with one pulse of a second type and a missed pulse.

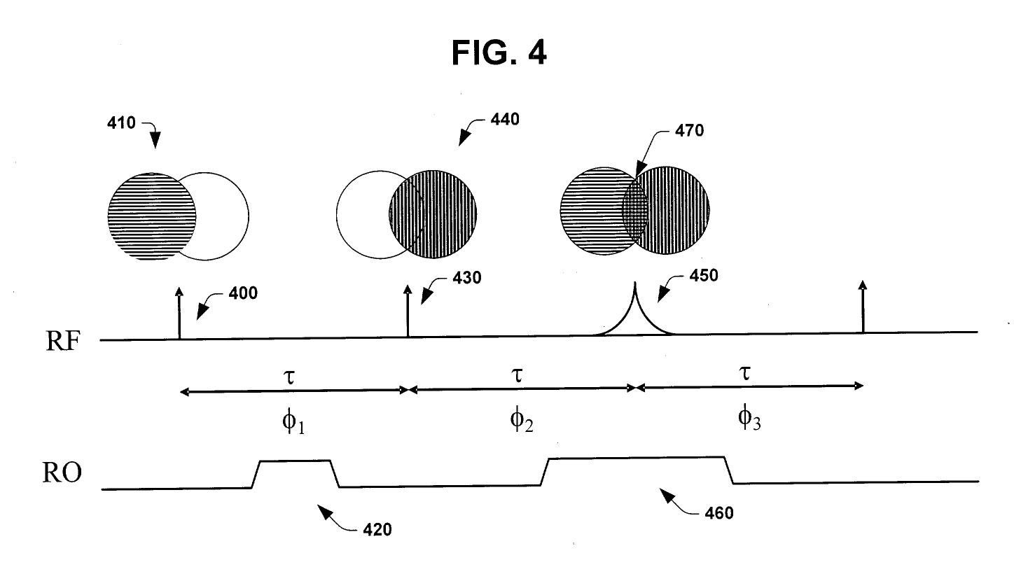

Turning now to FIG. 4, a general framework of the selective MP-SSFP sequence with two RF pulses per cycle is illustrated. The sequence includes a first RF pulse 400 and a second RF pulse 430. The RF pulses can be selected from a variety of spin excitations that include, but are not limited to, slice select, chemical shift selective, magnetization transfer pulses, and the like. Selective MP-SSFP simply requires that the two RF-excited spin groups intersect. The intersection may be derived through methods including, but not limited to, combinations of geographic relation, chemical shift, magnetization transfer, and so on. The spins that experience both pulses will refocus at the echo time, while spins that are exclusively excited by only one pulse will be dephased at the echo time and will not contribute any significant signal during acquisition. Thus, a first set of spins 410 may be excited by the first pulse 400 while a second, intersecting set of spins 440 may be excited by the second RF pulse 430. Then, at 450, the intersection 470 of spin sets 410 and 440 will emit a signal 450 that can be acquired during a missing pulse time.

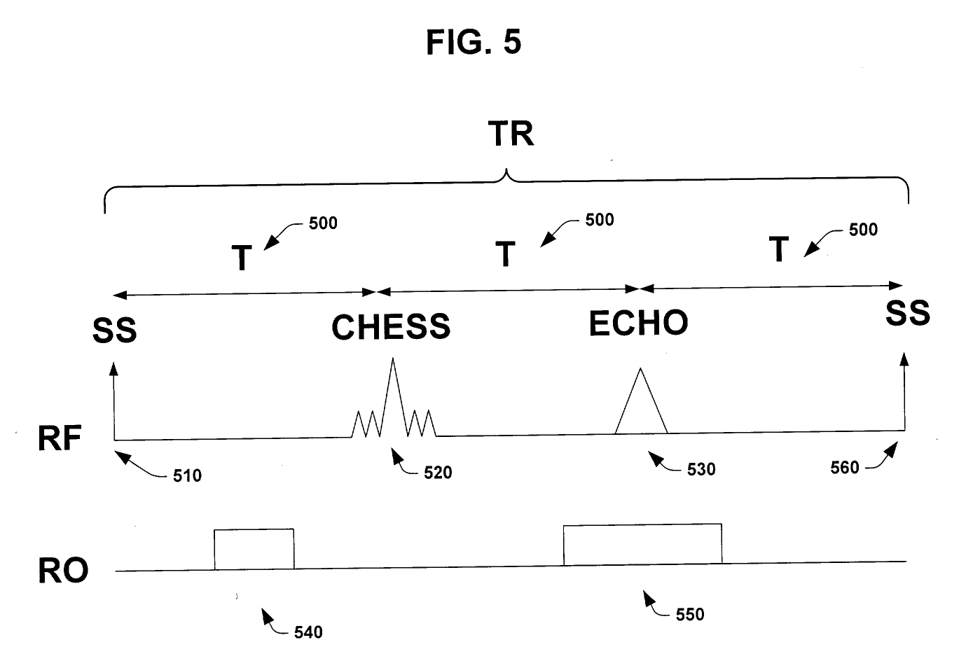

FIG. 5 illustrates an example MP-SSFP CHESS sequence that is both slice and chemical shift selective. In such an MP-SSFP CHESS sequence, a slice selective pulse is replaced with a CHESS pulse. As described in relation to FIG. 4, MP-SSFP sequences are distinguishable from conventional steady state sequences by the “missing pulse”. For example, every third RF pulse can be dropped and an MRI signal acquired during the “missing pulse” time. Then, an MRI image can be generated from the MR signal. FIG. 5 includes details that facilitate a more thorough understanding of an example MP-SSFP CHESS sequence. For example, TR is defined as the time from the center of a first RF pulse in one cycle to that of the next cycle. In FIG. 5, TR is divided into three equivalent time spaces T 500. At and/or during the first time space T 500 at 510, a first RF pulse is generated. At and/or during the second time space T 500 at 520, a CHESS RF pulse is generated. Then, at and/or during the third time space T 500 at 530 the echo generated by the intersection of the spins excited at 510 and 520 is collected. At 560, the MP-SSFP CHESS sequence begins again, repeating until terminated (e.g., under programmatic and/or human control).

In one example, processed on a Siemens Sonata 1.5T scanner, the time between RF pulses and an acquired echo is 7.6 ms, and a 256×256 image matrix is employed with a 256 mm×256 mm FOV. In the example, the bandwidth is 360 Hz/pixel and the acquisition time is 6.1 seconds. The CHESS pulse 520 is 9450 microseconds and can be centered at various frequencies to excite various sample components (e.g., fat, water, acetic acid). By way of illustration, the CHESS pulse 520 may be centered −255 Hz relative to the first RF pulse 510 to select for fat, 0 Hz relative to the first RF pulse 510 to select for water, and +550 Hz relative to the first RF pulse 510 to select for acetic acid. In one example, no read gradients are applied during the CHESS pulse. In the example, dropping every third pulse creates a steady state condition where the maximum signal is achieved at higher flip angles (e.g., 120-140 degrees) than in conventional SSFP sequences.

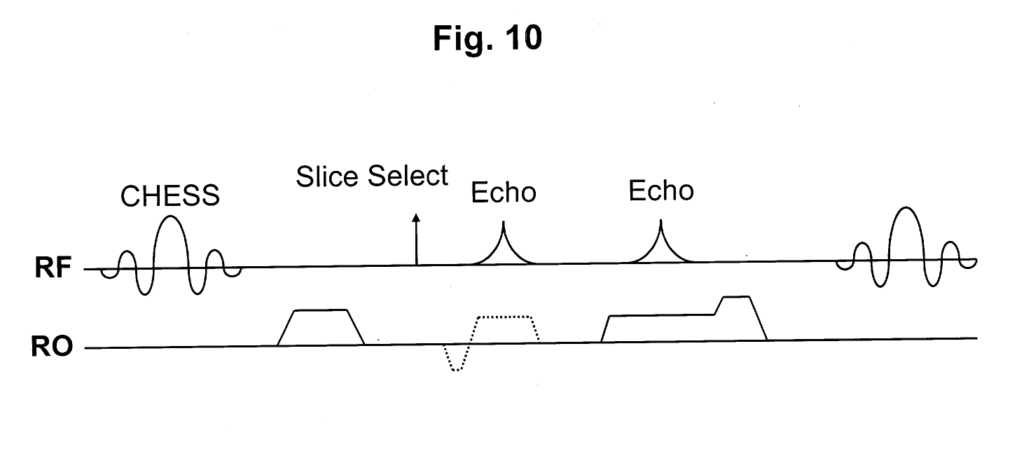

It is to be appreciated that the parameters discussed in association with FIG. 5 are merely examples, and that other combinations of parameters and/or pulse timings can be employed in accordance with aspects of the present invention. Additionally, another echo may be gathered within the same run of the sequence. A gradient refocused echo, like that encountered in fast imaging by steady precession (FISP), can be acquired within the same sequence for spins that are excited by only one of the RF pulses. The FISP-like signal can thus be employed, for example, to provide an additional image acquired during the MP-SSFP CHESS sequence without extending the overall acquisition time. If the accumulation in resonance offset angle is substantially constant for intervals, steady state conditions may be simultaneously maintained for FISP imaging of one set of spins and MP-SSFP CHESS imaging of the spins within the intersection. Graphics processing may be employed to correlate the images to produce improvements to MRI images. Thus, FIG. 10 illustrates a combined FISP/MP-SSFP sequence that facilitates exciting two or more sets of spins and acquiring a spin echo MR signal during a missing pulse period. The sequence in FIG. 10 also illustrates applying one or more rebalancing gradients during the MP-SSFP sequence to facilitate acquiring a gradient echo MR signal from sets of spins.

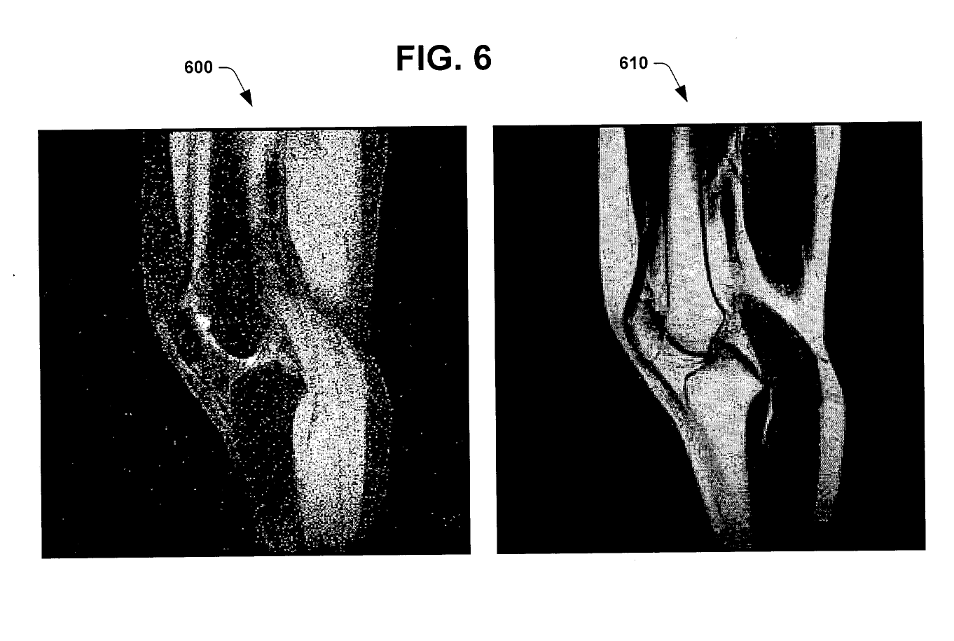

FIG. 6 illustrates two images of a knee, one acquired by MRI employing an MP-SSFP CHESS sequence that selects first for both water and fat and second for water, and one acquired with an MP-SSFP CHESS sequence that selects first for both water and fat and second for fat. The left image 600 is of a knee from a healthy volunteer, where the MP-SSFP sequence selected for water protons within a selected slice. Thus, since fat protons were not refocused during the missing pulse, fat was substantially completely suppressed from the image 600. Thus, fatty tissues (e.g., adipose tissue) do not obscure non-fatty tissues (e.g., lean muscle, tendon), providing advantages over conventional systems.

The right image 610 is of the same knee, where the MP-SSFP sequence selected for fat protons within the same selected slice. The contrast between the two images illustrates the improvements that can be achieved in MRI processing. For example, comparing the images reveals that substantially complete fat suppression occurred in the left image 600, and that substantially complete water suppression occurred in the right image 610. Thus, a viewer (e.g., surgeon, pathologist, neural network, artificial intelligence computer component) can be presented with an image of greater chemical shift selectivity, which facilitates interpreting the image.

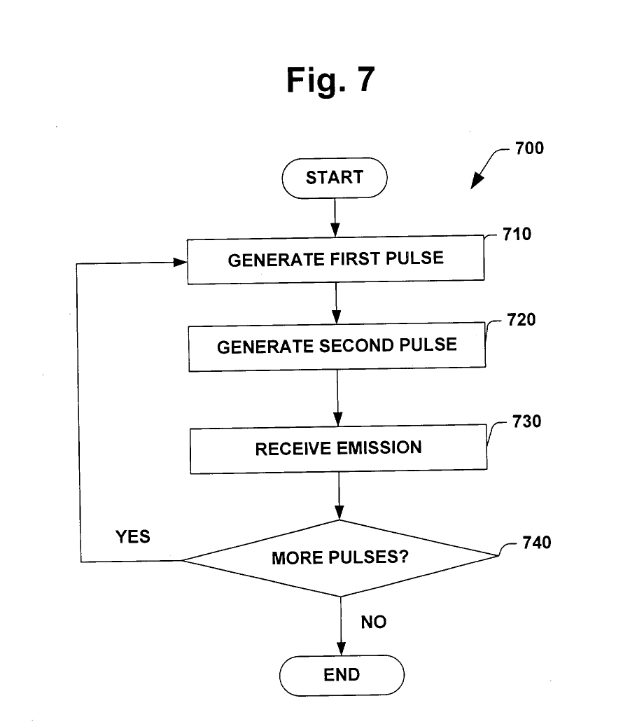

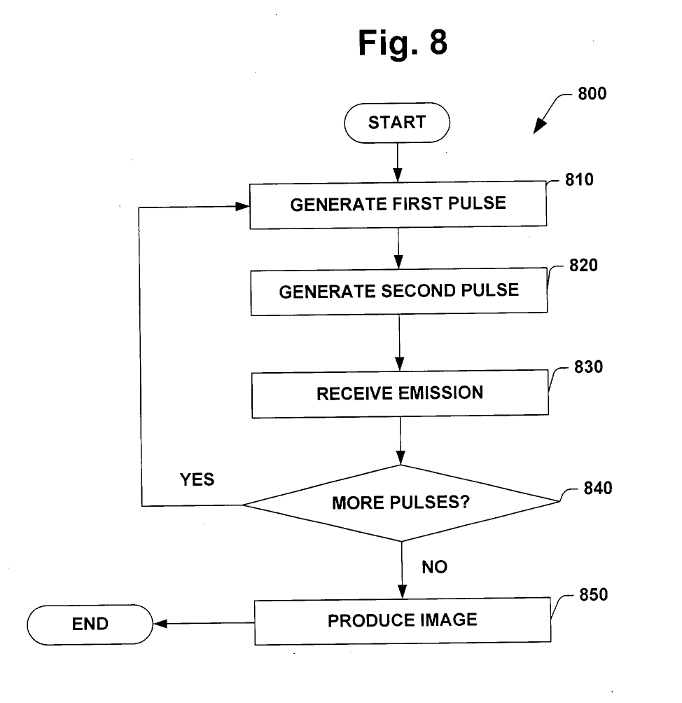

In view of the exemplary systems shown and described herein, example computer implemented methodologies will be better appreciated with reference to the flow diagrams of FIGS. 7 and 8. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick. It is to be appreciated that the methodologies can be implemented in software as that term is defined herein.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, routine loops, and so on are not shown.

FIG. 7 is a flow chart of one example method 700 for employing an MP-SSFP sequence (e.g., a CHESS sequence). At 710, a first RF pulse (or pulses) is generated. This first RF pulse may excite a first set of spins. For example, the first RF pulse may excite protons in either water or fat. Or, the first RF pulse may, for example, excite protons in a certain geographic area (e.g., slice) in a sample. At 720, in accordance with an MP-SSFP sequence that will set up a steady state precession, a second RF pulse (or pulses) is generated. The second RF pulse may excite a second set of spins. For example, the second RF pulse may excite substantially only protons in water. Or, the second RF pulse may, for example, excite only an intersecting volume of the slice excited by the first RF pulse at 710. Thus, from the set of protons excited a first time at 710, only a subset will be excited again at 720.

At 730, an MR signal emitted from the intersection of the spin sets excited by the first pulse at 710 and the second pulse at 720 will be received. The MR signal acquired at 730 can be processed in various manners known in the art (e.g., forming an image (see FIG. 8)). Since the set of spins from which the signal is acquired is more selective, the number, type, and/or severity of artifacts in the image derived from the signal received at 730 will be reduced. Thus, advantages are provided over conventional systems.

At 740, a determination is made concerning whether to generate any more pulses. If the determination at 740 is YES, processing returns to 710, otherwise processing can conclude. While the method 700 discusses protons associated with water and fat, it is to be appreciated that the RF pulses can be employed to excite spins associated with other compounds, elements, tissues, tissue components, and so on. Furthermore, while method 700 describes an MP-SSFP sequence with three phases (generating first pulse, generating second pulse, skipping pulse and acquiring signal during skipped pulse), it is to be appreciated that other MP-SSFP sequences may employ a greater and/or different number, type, and sequence of pulses and missed pulses, and that the selective adaptation of pulses to excite intersecting sets of spins is applicable to such MP-SSFP sequences. Additionally, pulses may excite two or more sets of spins, where two or more sets of the sets of spins may intersect. Thus, it is to be appreciated that example systems and methods described herein may not be limited to merely two sets of spins in three time period MP-SSFP sequences.

FIG. 8 is a flow chart of another example method 800 for employing an MP-SSFP sequence (e.g., a CHESS sequence). At 810, a first RF pulse is generated. This first RF pulse may, for example, excite protons in a slice of a sample subjected to the RF pulse. At 820, in accordance with an MP-SSFP sequence that will set up a steady state free precession, a second RF pulse is generated. The second RF pulse may, for example, excite substantially only protons in water. Thus, from the set of spins excited a first time at 810 (e.g., water and fat) only a subset will be excited again at 820 (e.g., water).

At 830, an MR signal emitted from the intersection of the spin sets excited by the first pulse at 810 and the second pulse at 820 will be received. The MR signal may be stored in a data store (e.g., data base, file, table) for later processing, and/or may be processed substantially in parallel.

At 840, a determination is made concerning whether there are more pulses to be generated. The determination can be made, for example, by an image viewer (e.g., pathologist, surgeon, neural network, artificial intelligence agent). The determination may also be made, for example, under programmatic control. For example, a pre-determined, configurable number of pulses may be programmed into a computer component to control the method 800. If the determination at 840 is YES, then processing returns to 810. But if the determination at 840 is NO, then processing proceeds to 850, where an image may be formed from one or more emissions received at 830. While block 850 is illustrated after and separate from block 830, it is to be appreciated that in another example, an image may be formed substantially in parallel with receiving emissions through, for example, a parallel processing system responsible for receiving emission data and rendering an image. In another example, emissions received at 830 may be stored in a data store (e.g., database, file, table) and processed after substantially all such signals have been received.

One example method employing MP-SSFP and FISP sequences includes replacing the first slice selective pulse of an MP-SSFP sequence with a CHESS pulse centered at a relative frequency offset to select a desired tissue component (e.g., −255 Hz for fat, 0 Hz for water, +550 Hz for acidic proton on acetic acid at 1.5T for protons). The method includes rebalancing gradients after the second slice select pulse to refocus the free induction decay of the pulse. The example method employs sequence parameters for fat and water processing like: TR=22.8 ms, acquisition matrix=256×256, FOV=256 mm×256 mm, slice thickness=10 mm, flip angle=120 degrees, bandwidth=345 Hz/pixel, total acquisition time=6.1 seconds, and CHESS pulse time=8980 microseconds. It is to be appreciated that these parameters are associated with one example, and that other combinations of parameters and pulse ordering can be employed in accordance with aspects of the present invention.

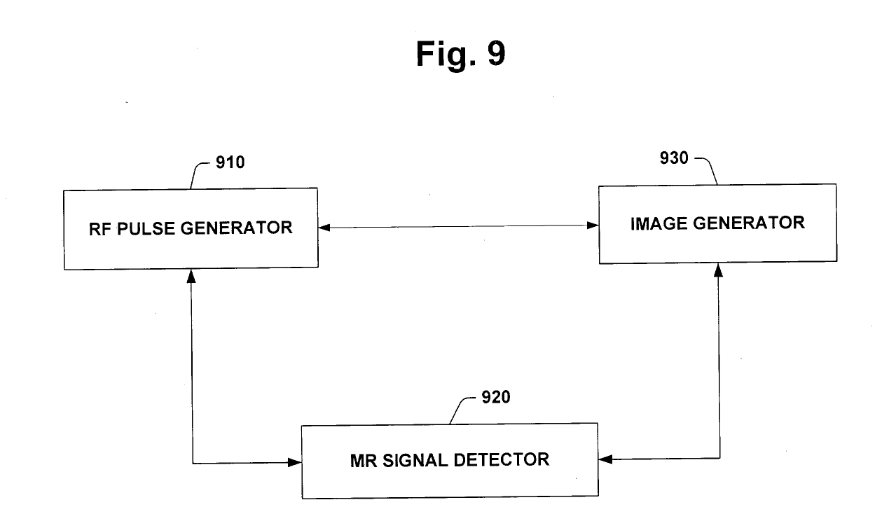

FIG. 9 illustrates an example system for producing an image from a signal acquired in response to an MP-SSFP sequence. One example MRI system can include an RF pulse generator 910 that generates an MP-SSFP sequence. One example MP-SSFP sequence can include a slice selective RF pulse and a CHESS RF pulse, for example. Another example MP-SSFP sequence can also include a slice selective RF pulse and an intersecting volume selecting RF pulse. While the application describes three phase sequences (e.g., slice selective pulse, altered pulse, missing pulse), it is to be appreciated that the pulse generator 910 can produce a variety of MP-SSFP sequences including a variety of pulses and missed pulses. The system also includes an MR signal detector 920 that acquires an MR signal from a set of spins refocused during a missing pulse in the MP-SSFP sequence. In one example, the set of spins are the intersection of spins excited during the slice selective RF pulse and the CHESS RF pulse. In another example, the set of spins are the intervolume spins. In yet another example, the set of spins are the spins excited exclusively by either the first RF pulse or the second RF pulse. Another example MRI system can include an image generator 930 that produces an image from the one or more signals acquired by the MR signal detector 920.

Computer readable and/or executable portions of the systems and methods described herein may be stored, for example, on a computer readable media. Media can include, but are not limited to, an ASIC, a CD, a DVD, a RAM, a ROM, a PROM, a disk, a carrier wave, a memory stick, and the like. Thus, an example computer readable medium can store computer executable instructions for computer implemented portions of a method that includes generating an MP-SSFP sequence that will excite the intersection of two spin sets, acquiring an MR signal from the intersection of the spins, and generating an image from the MR signal.

Similarly, a computer readable medium can store computer executable components of a system that includes an RF generator that produces an MP-SSFP sequence that excites a first set of spins in a sample and that excites a second set of spins in the sample, where the second set of spins intersects the first set of spins. The system may also include a signal detector that acquires an MR signal from the intersection of the first set of spins and the second set of spins and/or from spins that were excited by either the first RF pulse or the second RF pulse. The system may also include an image generator for producing an image from the acquired MR signal.

What has been described above includes several examples. It is, of course, not possible to describe every conceivable combination of components or methodologies for purposes of describing the methods, systems, computer readable media and so on employed in improving MRI images via MP-SSFP CHESS sequences. However, one of ordinary skill in the art may recognize that further combinations and permutations are possible. Accordingly, this application is intended to embrace alterations, modifications, and variations that fall within the scope of the appended claims. Furthermore, to the extent that the term “includes” is employed in the detailed description or the claims, it is intended to be inclusive in a manner similar to the term “comprising” as that term is interpreted when employed as a transitional word in a claim.

What is claimed is:

1. An MP-SSFP method, comprising:
exciting a first set of spins during a first RF pulse;
exciting a second set of spins during a second RF pulse, where the second set of spins intersects with the first set of spins;
skipping a third pulse; and
acquiring an MR signal from the intersection of the first and second set of spins.

2. The method of claim 1, comprising:
producing an image from the MR signal.

3. The method of claim 2, where the first and second set of spins are distinguished based on geographic location.

4. The method of claim 2, where the first and second set of spins are distinguished based on chemical composition.

5. A computer readable medium storing computer executable instructions operable to perform the method of claim 1.

6. An MP-SSFP method, comprising:
exciting a first set of spins during a first RF pulse;
exciting a second set of spins during a second RF pulse, where the second set of spins intersects with the first set of spins;
skipping a third pulse; and
acquiring an MR signal from spins that were excited by only one of, the first RF pulse, and the second RF pulse.

7. The method of claim 6, comprising:
producing an image from the MR signal.

8. The method of claim 6, where the first and second set of spins are distinguished based on geographic location.

9. The method of claim 6, where the first and second set of spins are distinguished based on chemical composition.

10. A computer readable medium storing computer executable instructions operable to perform the method of claim 6.

11. An MP-SSFP method, comprising:
producing a slice selective RF pulse;
producing a CHESS RF pulse;
skipping a pulse; and
acquiring an MR signal from spins that refocus during the skipped pulse, where the spins were excited by both the slice selective RF pulse and the CHESS RF pulse.

12. The method of claim 11, comprising:
producing an image from the MR signal.

13. An MP-SSFP method, comprising:
producing a slice selective RF pulse;
producing a CHESS RF pulse;
skipping a pulse; and
acquiring an MR signal from spins that refocus during the skipped pulse, where the spins were excited by only one of, the slice selective RF pulse, and the CHESS RF pulse.

14. The method of claim 13, comprising:
producing an image from the MR signal.

15. An MP-SSFP method, comprising:
producing a slice selective RF pulse;
producing an intersecting volume selective RF pulse;
skipping a pulse; and
acquiring an MR signal from spins that refocus during the skipped pulse, where the spins were excited by both the slice selective RF pulse and the intersecting volume selective RF pulse.

16. The method of claim 15, comprising:
producing an image from the MR signal.

17. An MRI system, comprising:
an RF pulse generator that generates an MP-SSFP sequence including one or more slice selective RF pulses and one or more CHESS RF pulses; and
an MR signal detector that acquires an MR signal from a set of spins refocused during one or more missing pulses in the MP-SSFP sequence, where the set of spins is the intersection of spins excited during the one or more slice selective RF pulses and the one or more CHESS RF pulses.

18. The system of claim 17, comprising:
an image generator that produces an image from the MR signal.

19. An MRI system, comprising:
an RF pulse generator that generates an MP-SSFP sequence including one or more slice selective RF pulses and one or more intersecting volume selective RF pulses; and
an MR signal detector that acquires an MR signal from a set of spins refocused during one or more missing pulses in the MP-SSFP sequence.

20. The system of claim 19, where the set of spins is the intersection of spins excited during the slice selective RF pulses and the intersecting volume selective RF pulses.

21. The system of claim 19, where the set of spins comprises spins excited exclusively by either the slice selective RF pulses or the intersecting volume selective RF pulses.

22. The system of claim 19, comprising:
an image generator that produces an image from the MR signal.

23. An MRI system, comprising:
means for exciting a first set of spins in a sample;
means for exciting a second set of spins in a sample, where the second set of spins intersects the first set of spins; and
means for acquiring an MR signal from the intersection of the first set of spins and the second set of spins.

24. The system of claim 23, comprising:
means for producing an image from the acquired MR signal.

25. A system for producing an MRI image, comprising:
a magnetic resonance imager for acquiring an MRI data from the intersection of a first set of spins excited by one or more first RF pulses in an MP-SSFP sequence and a second set of spins excited by one or more second RF pulses in the MP-SSFP sequence, where the first and second sets of spins are different but intersecting; and
an image reconstructor for reconstructing an image from the MRI data.

26. The system of claim 25, the magnetic resonance imager comprising:
a polarizing magnetic field generator for generating a polarizing magnetic field in an examination region;
an RF generator for generating an excitation magnetic field that produces transverse magnetization in nuclei subjected to the polarizing magnetic field;
a sensor for sensing a magnetic resonance signal produced by the transverse magnetization;
a gradient generator for generating a magnetic field gradient to impart a read component into the magnetic resonance signal, where the read component indicates a location of a transversely magnetized nuclei along a first projection axis, the gradient generator generating subsequent magnetic field gradients to impart subsequent read components into the magnetic resonance signal that indicates subsequent locations of the transversely magnetized nuclei along subsequent projection axes;
a pulse controller operably coupled to the RF generator, the gradient generator, and the sensor, the pulse controller conducting a scan in which a series of data points are acquired at read points along a radial axis to form a magnetic resonance data view, subsequent magnetic resonance data views defining a magnetic resonance data set;
a data store for storing the magnetic resonance data set; and
a processor for reconstructing an image array for a display from the stored magnetic resonance data set.

27. A method for acquiring a signal in response to a steady state sequence that refocuses spins excited by a combination of RF pulses, where the combination of RF pulses excites at least two different, intersecting sets of spins, comprising:
producing one or more slice selective RF pulses;
producing one or more CHESS RF pulses;
skipping one or more pulses; and
acquiring an MR signal from spins that refocus during the one or more skipped pulses, where the spins were excited by one or more of the slice selective RF pulses and one or more of the CHESS RF pulses.

28. The method of claim 27, where the spins were excited by only a slice selective pulse or a CHESS RF pulse.

29. The method of claim 27, comprising:
producing an image from the MR signal.

30. A computer readable medium storing computer executable instructions operable to perform the method of claim 27.

31. A method for acquiring a signal in response to a steady state sequence that refocuses spins excited by a combination of RF pulses, where the combination of RF pulses excites at least two different, intersecting sets of spins, comprising:
producing two or more intersecting slice selective RF pulses;
skipping one or more pulses; and
acquiring an MR signal from spins that refocus during the one or more skipped pulses, where the spins were excited by two or more of the slice selective RF pulses.

32. The method of claim 31, comprising:
producing an image from the MR signal.

33. A computer readable medium storing computer executable instructions operable to perform the method of claim 31.

34. An MRI system, comprising:
means for exciting one or more intersecting sets of spins in a sample; and
means for acquiring an MR signal from one or more of the intersecting sets of spins.

35. The system of claim 34, comprising:
means for producing an image from the MR signal.

36. An MP-SSFP signal acquiring method, comprising:
exciting two or more sets of spins using an MP-SSFP sequence;
acquiring a spin echo MR signal during a missing pulse period, where the spin echo MR signal is from an intersection of two sets of the two or more sets of spins;
applying one or more rebalancing gradients during the MP-SSFP sequence; and
acquiring a gradient echo MR signal from a union of two sets of the two or more sets of spins.

37. An MP-SSFP method, comprising:
applying one or more first RF pulses to excite one or more sets of first spins;
applying one or more second RF pulses to excite one or more sets of second spins, where the one or more sets of the second spins intersect with one or more sets of the first spins;
skipping one or more pulses; and
acquiring one or more MR signals from one or more intersections of first spins and second spins.

38. An MP-SSFP method, comprising:
applying one or more first RF pulses to excite one or more sets of first spins;
applying one or more second RF pulses to excite one or more sets of second spins, where the one or more sets of second spins intersect with one or more sets of first spins;
skipping one or more pulses; and
acquiring one or more MR signals from spins that were excited by only one of, the first RF pulses, and the second RF pulses.

39. An MP-SSFP method, comprising:
producing one or more slice selective RF pulses;
producing one or more intersecting volume selective RF pulses;
skipping one or more pulses; and
acquiring one or more MR signals from spins that refocus during a skipped pulse, where the spins were excited by one or more slice selective RF pulses and one or more intersecting volume selective RF pulses.
